(19) United States
(12) Patent Application Publication
(10) Pub. No.: US 2013/0294099 A1
(43) Pub. Date: Nov. 7, 2013

(54) FLEXIBLE TUBE AND LAMP HAVING THE SAME

(71) Applicant: Duan-Cheng Hsieh, Taipei City (TW)

(72) Inventor: Duan-Cheng Hsieh, Taipei City (TW)

(73) Assignee: Habitex Corporation, Taipei City (TW)

(21) Appl. No.: 13/460,945

(22) Filed: May 1, 2012

(51) Int. Cl. F21V 21/32; B32B 1/08; F16L 11/12

(52) U.S. Cl. 362/430; 428/36.9; 428/36.91

(57) ABSTRACT

A flexible tube is adapted to be sleeved on a power cable, and includes a flexible tube body and at least one flexible wire. The flexible tube body is adapted to be sleeved on the power cable, is made of a plastic material, and is formed with a central hole and at least one through hole that are formed therethrough, that extend along the length thereof, and that are spaced apart from each other. The central hole is adapted to permit extension of the power cable therethrough. The flexible wire extends through and is secured within the through hole in the flexible tube body.

### BACKGROUND OF THE INVENTION

1. Field of the Invention

This invention relates to a tube, and more particularly to a flexible tube and a lamp having the same.

2. Description of the Related Art

A zigzag tube has been proposed to be connected between a lamp base and a lamp head of a desk lamp in order to allow for adjustment to the projection angle of the desk lamp. However, such a zigzag tube is made of a metallic material in order to provide sufficient support to the lamp head, thereby resulting in an increase in the manufacturing cost of the desk lamp.

### SUMMARY OF THE INVENTION

An object of this invention is to provide a flexible tube that can provide sufficient support and that is made at a low cost.

Another object of this invention is to provide a lamp having a flexible that can provide sufficient support and that is made at a low cost.

According to an aspect of this invention, there is provided a flexible tube adapted to be sleeved on a power cable, the flexible tube comprising:

a flexible tube body adapted to be sleeved on the power cable, the flexible tube body being made of a plastic material and being formed with a central hole and at least one through hole that are formed therethrough, that extend along the length thereof, and that are spaced apart from each other, the central hole being adapted to permit extension of the power cable therethrough; and

at least one flexible wire extending through and being secured within the through hole in the flexible tube body.

According to another aspect of this invention, there is provided a lamp comprising:

a supporting member;

a lamp head;

a power cable electrically connected to the lamp head; and

a flexible tube having two ends connected respectively to the supporting member and the lamp head, the flexible tube including
a flexible tube body sleeved on the power cable, the flexible tube body being made of a plastic material and being formed with a central hole and at least one through hole that are formed therethrough, that extend along the length thereof, and that are spaced apart from each other, the central hole permitting extension of the power cable therethrough, and
at least one flexible wire extending through and being secured within the through hole in the flexible tube body.

As such, since the flexible tube body is made of the plastic material, the manufacturing cost of the lamp can be reduced. Furthermore, the flexible wire can provide sufficient support to the lamp head.

### BRIEF DESCRIPTION OF THE DRAWINGS

These and other features and advantages of this invention will become apparent in the following detailed description of the preferred embodiments of this invention, with reference to the accompanying drawings, in which:

FIG. 1 is a side view of the first preferred embodiment of a lamp according to this invention;

FIG. 2 is a perspective view of a flexible tube of the first preferred embodiment;

FIG. 3 is a cross sectional view of an assembly of the flexible tube and a power cable of the first preferred embodiment;

FIG. 4 is a longitudinal sectional view of the assembly of the flexible tube and the power cable of the first preferred embodiment;

FIG. 5 is a side view of the second preferred embodiment of a lamp according to this invention; and

FIG. 6 is a side view of the second preferred embodiment of a lamp according to this invention.

### DETAILED DESCRIPTION OF THE PREFERRED EMBODIMENTS

Before the present invention is described in greater detail in connection with the preferred embodiments, it should be noted that similar elements and structures are designated by like reference numerals throughout the entire disclosure.

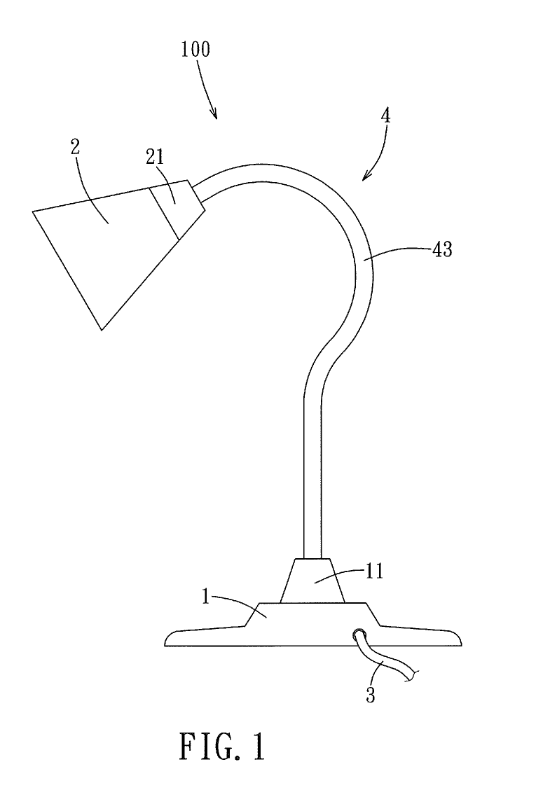

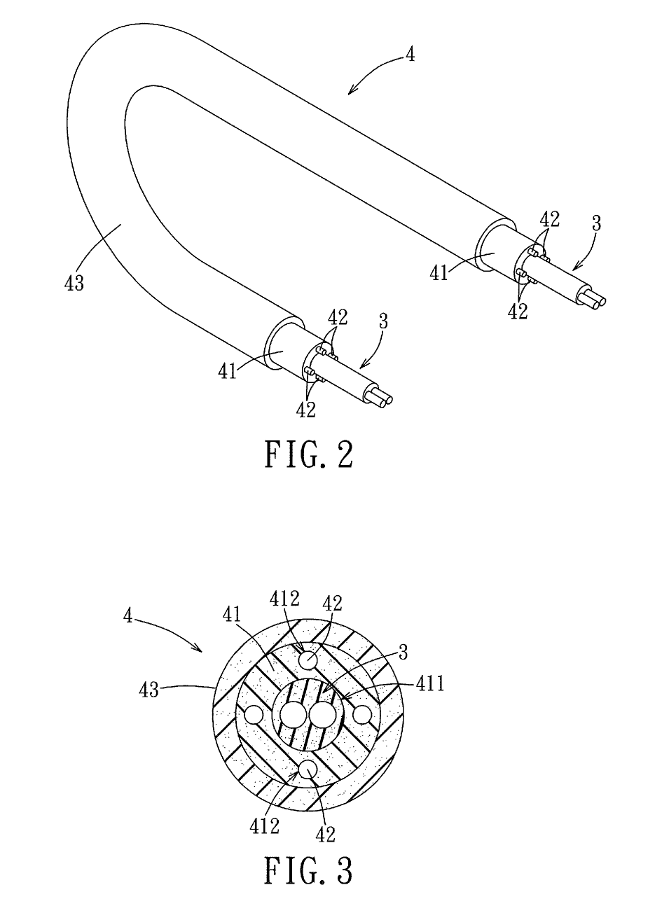

Referring to FIGS. 1 and 2, the first preferred embodiment of a lamp 100 according to this invention is exemplified using a desk lamp, and includes a supporting member 1, a lamp head 2, a power cable 3 electrically connected to the lamp head 2, and a flexible tube 4. The flexible tube 4 has two ends connected respectively to the supporting member 1 and the lamp head 2. Alternatively, the lamp 100 may be a tool lamp or any other lamp adjustable to change the projection angle of the light head 2.

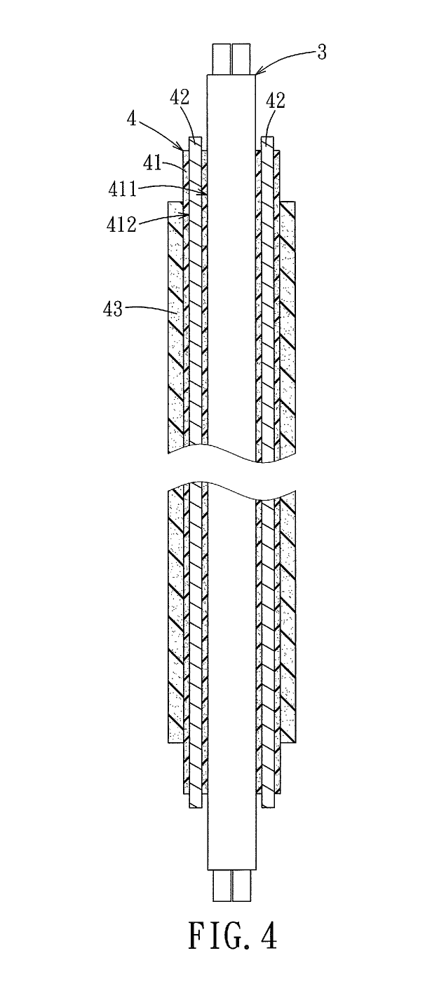

With further reference to FIGS. 3 and 4, the flexible tube 4 includes a flexible tube body 41 sleeved on the power cable 3, and at least one flexible wire 42. The flexible tube body 41 is made of a plastic material, and is formed with a central hole 411 and at least one through hole 412 that are formed therethrough, that extend along the length thereof, and that are spaced apart from each other. The power cable 3 extends through the central hole 411. The flexible wire 42 extends through and is secured within the through hole 412. Due to inclusion of the flexible wire 42 within the flexible tube 4, when changed, the shape of the flexible tube 4 can be maintained. By changing the shape of the flexible tube 4, the projection angle of the lamp 100 can be adjusted.

In this embodiment, the flexible tube body 41 is made of Polypropylene (PP) or polyvinylchloride (PVC), and the flexible wire 42 is made of aluminum or iron. As such, since the plastic tube body 41 acts as the main body of the flexible tube 4, the manufacturing cost of the lamp 100 can be reduced significantly. Furthermore, since the flexible wire 42 serves to maintain the shape of the main body, sufficient support to the lamp head 2 can be provided thereby. In this embodiment, the tube body 41 is formed with a plurality of through holes 412 disposed around the central hole 411, and the flexible tube 4 includes a plurality of flexible wires 42 extending through the through holes 412, respectively.

With particular reference to FIGS. 1 and 2, the supporting member 1 is disposed on a supporting surface (not shown), such as a top surface of a desk, and is provided with a sleeve tube 11 sleeved fixedly on a bottom end of the flexible tube body 41 by a rivet, an adhesive, a bolt, or a tongue-and-groove engagement. The lamp head 2 is provided with a coupling sleeve 21 sleeved fixedly on a top end of the flexible tube body 41 by a rivet, an adhesive, a bolt, or a tongue-and-groove engagement.

With particular reference to FIGS. 2, 3, and 4, the flexible tube 4 further includes a tubular ornamental member 43 sleeved fixedly on the flexible tube body 41. The tubular ornamental member 43 is made of a plastic material, such as PP and PVC, and can be designed to have a specific color or a specific profile so as to provide anesthetic appearance. Or, the tubular ornamental member 43 may be of the same color as the supporting member 1 and the lamp head 2, so that the outer surface of the lamp 100 as a whole is of a single color.

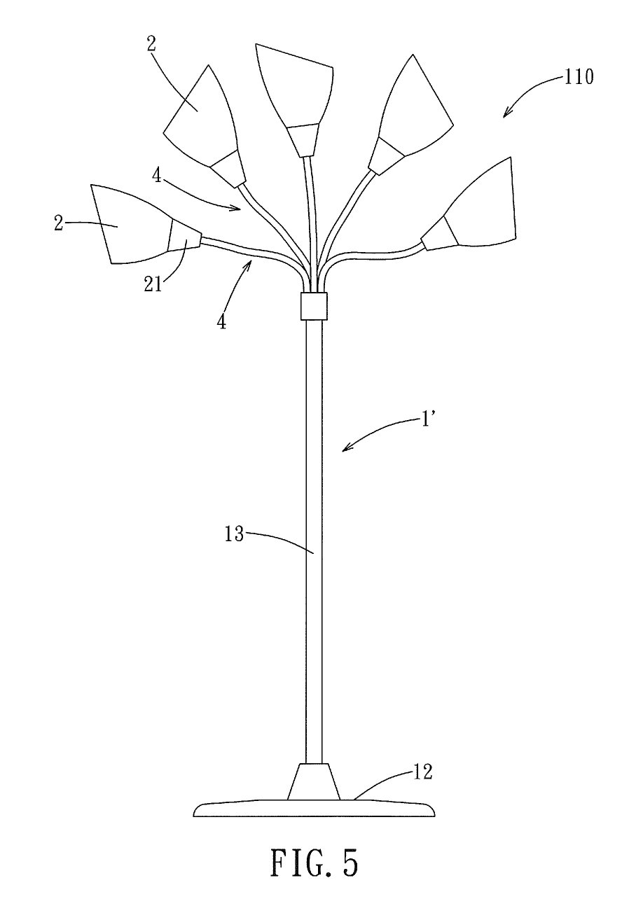

FIG. 5 shows the second preferred embodiment of a lamp 110 according to this invention, which is similar in construction to the first preferred embodiment.

In this embodiment, the supporting member 1′ includes a base 12 and an upright tube 13 fixed on and above the base 12. The lamp 110 includes a plurality of lamp heads 2 and a plurality of flexible tubes 4. Each of the flexible tubes 4 has two ends connected respectively to a top end of the upright tube 13 and the coupling sleeve 21 of a respective one of the lamp heads 2 by a rivet, an adhesive, a bolt, or a tongue-and-groove engagement. As such, the lamp 110 looks like a tree, and the projection angle of each of the lamp heads 2 can be adjusted.

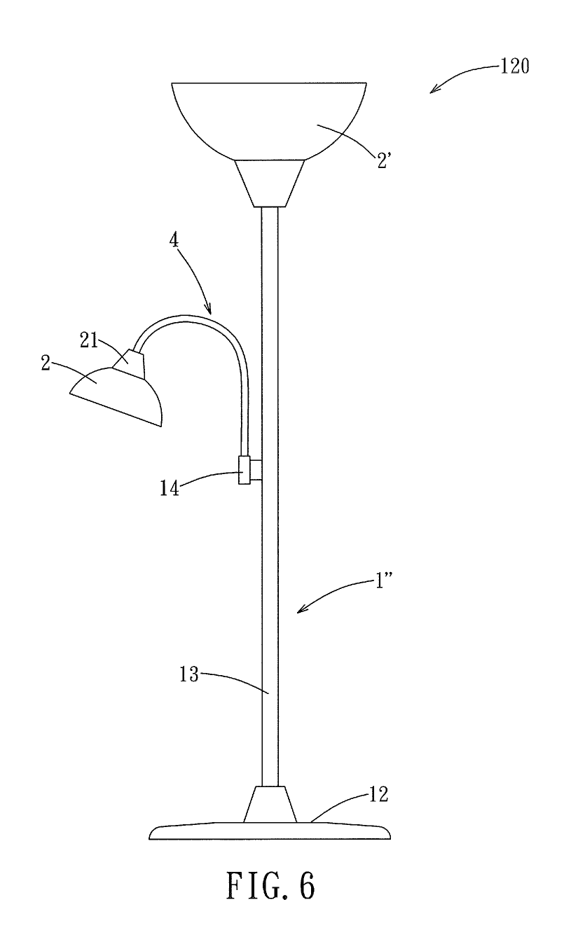

FIG. 6 shows the third preferred embodiment of a lamp 120 according to this invention, which is also similar in construction to the first preferred embodiment except that the structure of the supporting member 1″ is changed, and a fixed lamp head 2′ is added, and is fixed directly on a top end of the supporting member 1″.

In this embodiment, the supporting member 1″ includes a base 12, an upright tube 13 fixed on and above the base 12, and a mounting tube 14 projecting laterally from a middle portion of the upright tube 13. The flexible tube 4 has two ends connected respectively to the mounting tube 14 and the coupling sleeve 21. The mounting tube 14 maybe sleeved fixedly on a bottom end of the flexible tube 4 by a rivet, an adhesive, a bolt, or a tongue-and-groove engagement.

In view of the above, due to the presence of the plastic tube body 41, the lamp 100, 110, 120 can be made at a low cost. Furthermore, due to the disposition of the flexible wire or wires 42 within the plastic tube body 41, sufficient support can be provided to the lamp head or heads 2. Thus, the objects of this invention are achieved.

With this invention thus explained, it is apparent that numerous modifications and variations can be made without departing from the scope and spirit of this invention. It is therefore intended that this invention be limited only as indicated by the appended claims.

I claim:

1. A flexible tube adapted to be sleeved on a power cable, said flexible tube comprising:
a flexible tube body adapted to be sleeved on the power cable, said flexible tube body being made of a plastic material and being formed with a central hole and at least one through hole that are formed therethrough, that extend along the length thereof, and that are spaced apart from each other, said central hole being adapted to permit extension of the power cable therethrough; and
at least one flexible wire extending through and being secured within said through hole in said flexible tube body.

2. The flexible tube as claimed in claim 1, wherein said flexible tube body is formed with a plurality of said through holes disposed around said central hole, and said flexible tube comprises a plurality of said flexible wires extending through said through holes, respectively.

3. The flexible tube as claimed in claim 1, further comprising a tubular ornamental member sleeved on said flexible tube body.

4. A lamp comprising:
a supporting member;
a lamp head;
a power cable electrically connected to said lamp head; and
a flexible tube having two ends connected respectively to said supporting member and said lamp head, said flexible tube including
a flexible tube body sleeved on said power cable, said flexible tube body being made of a plastic material and being formed with a central hole and at least one through hole that are formed therethrough, that extend along the length thereof, and that are spaced apart from each other, said central hole permitting extension of said power cable therethrough, and
at least one flexible wire extending through and being secured within said through hole in said flexible tube body.

5. The lamp as claimed in claim 1, wherein said flexible tube body is formed with a plurality of said through holes disposed around said central hole, and said flexible tube comprises a plurality of said flexible wires extending through said through holes, respectively.

6. The lamp as claimed in claim 1, further comprising a tubular ornamental member sleeved on said flexible tube body.
